(19) United States
(12) Patent Application Publication
(10) Pub. No.: US 2009/0187925 A1
(43) Pub. Date: Jul. 23, 2009

(54) Driver that efficiently regulates current in a plurality of LED strings

(75) Inventors: Yuequan Hu, Morrisville, NC (US); Milan M. Jovanovic, Cary, NC (US); Colin Weng, Taipei (TW)

Correspondence Address: VENABLE LLP, P.O. BOX 34385, WASHINGTON, DC, 20043-9998, US

(73) Assignee: Delta Electronic Inc., Taipei (TW)

(21) Appl. No.: 12/007,968

(22) Filed: Jan. 17, 2008

(51) Int. Cl. G09G 3/36

(52) U.S. Cl. 719/327

(57) ABSTRACT

A light-emitting diode (LED) driver according to the present invention consists of a voltage pre-regulator and multiple linear current regulators with an adaptively-controlled drive voltage. In this LED driver, the efficiency maximization is achieved by eliminating the sensing of the voltage drops across the linear regulators, i.e., by removing the external voltage feedback for the adjustment of the output voltage of the pre-regulator. In the LED driver of the present invention, the self-adjustment of drive voltage is achieved by relying on a relatively strong dependence between the gate-to-source and drain-to-source voltages of a current-regulating transistor, e.g., a MOSFET, operating in the linear region. The driver powers all LEDs in a string with a constant current and provides consistent illumination and optimum operating efficiency at low cost over a wide range of input/output voltage and temperature.

### FIELD OF THE INVENTION

This invention relates to an LED driver, more specifically, to an LED driver that regulates current in LED strings.

### BACKGROUND OF THE INVENTION

A light-emitting diode (LED) is a semiconductor device that emits light when electrically biased in the forward direction of its p-n junction. The color of the emitted light depends on the composition and condition of the semiconducting material used, and can be infrared, visible, or near-ultraviolet.

LED backlighting is used in small, inexpensive Liquid Crystal Display (LCD) panels. The light is usually colored, although white LED backlighting is becoming more common. LED backlighting in larger displays helps to improve the color representation of the LCD display. LED light is created by separate LEDs to produce a color spectrum that closely matches the color filters in the LCD pixels themselves. The advantages of LED backlighting are extremely long life (100K hours vs. 30K hours for typical CCFL backlighting), ruggedness, low operational voltage, and precise control over its intensity.

The brightness of an LED is directly related to the current applied. However, even with the same driving current, the forward voltage developed across LEDs has a wide range depending primarily upon the semiconductor design, technology used, and manufacturing tolerances. Table I shows the forward voltage drop of Luxeon I LEDs from LumiLEDs Corporation. The difference between maximum and minimum forward voltage drop of these LEDs is 1.2V.

TABLE I
Forward voltage drop of LEDs

| | |
|---|---|
| V_{FLED} (V) | Luxeon I LEDs |

| at 350 mA | Red | Green | Blue | White |
|---|---|---|---|---|
| Minimum | 2.31 | 2.79 | 2.79 | 2.79 |
| Typical | 2.95 | 3.42 | 3.42 | 3.42 |
| Maximum | 3.51 | 3.99 | 3.99 | 3.99 |

LEDs need to be driven by a constant current source in order to achieve controlled luminance and avoid over-current failure when using a voltage source as a power supply. An effective way to ensure that each LED produces similar light output is to connect them in series. However, a major drawback of series connection of LEDs is the cumulative voltage drop that eventually limits the number of LEDs in series. On the other hand, simple paralleling of LEDs or LED strings is not desirable because of current sharing problems related to the LED's exponential voltage-current characteristic with a negative temperature coefficient of the forward voltage.

Generally, there are three possible parallel connections for operating multiple LED strings. FIG. 1 shows multiple linear current regulator circuits that can be fabricated inexpensively to provide constant current to corresponding number of LED strings, each having a plurality of serially coupled LEDs. Because of the requirement for lower total voltage for forward biasing the LEDs in each string relative to the supply voltage, however, the circuit of FIG. 1 has poor efficiency especially when the voltage drops across the linear current regulators are high.

FIG. 2 shows independent switching current regulators driving each LED string with voltage step-up or/and step-down capability. This approach has the advantage of automatically adjusting the supply voltage for each LED string so that the LEDs operate at fairly matched current and light output levels. Although this approach has a higher operating efficiency, it also has a higher component count and cost when driving multiple LED strings.

FIG. 3 shows multiple linear current regulators that drive corresponding LED strings using a source voltage provided by a pre-regulator. The combination of the pre-regulator with linear regulators can result in lower component count and cost. However, with the conventional approach shown in FIG. 3, the output voltage of the pre-regulator needs to be set to a high level to achieve uniform illumination of the LEDs, leading to a poor operating efficiency. For example, if each LED string has n LEDs of the same color, the output voltage of the pre-regulator needs to be at least n times the maximum forward voltage drop VFMAX plus the minimum voltage drop across the linear regulator itself to ensure the current of any LED string is maintained constant. The efficiency of the string with LEDs of minimum forward voltage drop VFMIN is approximately VFMIN/VFMAX, i.e., 65.81% for Luxeon I red LEDs (characterized by Table I above) at 350 mA, indicating 34.19% of the output power is dissipated by the linear regulator creating thermal management problem. Alternatively, LEDs can be manufactured to a close tolerance or with matched parameters established by testing so that a minimum output voltage of the pre-regulator can be set for maximum efficiency. This inevitably drives up cost.

FIG. 4 shows still another conventional LED driver circuit disclosed in U.S. Pat. No. 6,690,146. Under this approach, a maximum-voltage detector consisting of “OR-ed” diodes detects the lowest voltage drop across linear current regulators of a plurality of LED strings and a comparator circuit generates an error signal based on the comparison of the detected voltage VMIN and a reference voltage VREF. The error signal is used as a feedback signal by a pre-regulator to provide a voltage that ensures the lowest voltage sensed is held at a level that leads to a regulated current for the LED string having the highest forward voltage drop. The advantage of the LED driver circuit of FIG. 4 is that the supply voltage for the linear regulators is automatically adjusted based on the actual maximum forward voltage drop of the LED strings to maintain current regulation. However, the efficiency performance of this approach is strongly affected by the selection of reference voltage VREF and characteristics of the sensing diodes, primarily their temperature dependence. Because of the tolerances of minimum voltage drops of linear current regulators, i.e., tolerances of dropout voltages, reference voltage VREF must be selected above the anticipated worst-case voltage, which is the highest dropout voltage expected. As a result of an increased reference voltage required to provide the worst-case design margin, the efficiency of the driver in FIG. 4 is always lower than the possible maximum efficiency. Moreover, because of the strong temperature dependence of the forward voltage drop of the detector diodes used to detect the minimum voltage, the actual minimum voltage drop varies with the operating temperature. For example, if the reference voltage is 1.0 V and the forward voltage of detector diodes changes from 0.7 V to 0.5 V because of a temperature rise, the controlled minimum voltage of the linear regulator varies from 0.3 V to 0.5 V, leading to a 66.7% increase of power loss of the linear regulator for the same LED current. Accordingly, the power loss of all other linear regulators increases due to respective increase of voltage drop, significantly decreasing the overall efficiency of the LED driver.

Therefore, there exists a need for an LED driver circuit that adaptively controls the supply voltage based on the actual forward voltage of LED strings while maintaining constant current regulation of LEDs as well as achieving optimal and consistent operating efficiency.

### SUMMARY OF THE INVENTION

Briefly, according to the present invention, an LED driver has a power supply having an adjustable output voltage. A plurality of LED strings comprising one or more LEDs are coupled to the adjustable output voltage in parallel to generate a plurality of current flows through each LED string. Each LED string has a corresponding cumulative forward voltage related to the sum of the forward voltages of the one or more LEDs in such LED string. Accordingly, each LED string represents a load having a corresponding voltage drop. A plurality of control circuits coupled to a corresponding one of the plurality of the LED strings generate a plurality of control signals such that each control signal has a level corresponding to the cumulative forward voltage of a correspondingly coupled LED string. A plurality of current regulating transistors regulate the current flows through a corresponding one of the plurality of LED strings in response to a correspondingly coupled control signal. Each of the plurality of control signals controls the voltage drop across a corresponding one of the plurality of current regulating transistors. A detector that detects a control signal corresponding to the highest cumulative forward voltage of one of the plurality of LED strings. A feedback circuit that provides a feedback signal corresponding to the detected control signal for adjusting the output voltage of the power supply so that the current regulating transistors maintain current regulation of LEDs with a minimum supply voltage.

According to some of the more detailed features of the present invention, at least one of the plurality of control signals comprises an error signal derived from a sensed current flow through an LED string and a reference signal. The detector circuit comprises a plurality of diodes forming an OR circuit.

According to other more detailed features of the invention, the power supply comprises a switching pre-regulator, such as a SEPIC (single-ended primary inductance converter). The output of the switching power supply is controlled by the duty cycle of a pulse-width-modulated (PWM) signal, where the duty cycle of the PWM signal is changed in response to the feedback signal. At least one the plurality of the current regulating transistors comprises a MOSFET. At least one current regulating transistor is preferably operated in the linear region to minimize the output voltage of the power supply. The feedback control circuit preferably incorporates a level shifter, which shifts the maximum output of the error-amplifiers by a fixed level to further improve the performance of the driver of the invention, i.e., to adjust the drive voltage of LED strings for optimum operating efficiency.

### BRIEF DESCRIPTION OF THE DRAWINGS

FIG. 1 shows a prior art LED driver circuit having linear constant current LED drivers.

FIG. 2 shows a prior art LED driver circuit having switching constant current LED drivers.

FIG. 3 shows a prior art LED driver circuit having linear constant current LED driver with switching voltage pre-regulator.

FIG. 4 shows a prior art LED driver circuit having diode detection circuits for detecting the minimum voltage drop across linear current regulators.

FIG. 5 shows the schematic diagram for an exemplary LED driver according to one embodiment of the present invention.

FIG. 6 shows the plot of gate-to-source voltage vs. drain-to-source voltage of a MOSFET for various currents.

FIG. 7 shows an exemplary LED driver circuit with switching pre-regulator according to one embodiment of the present invention.

FIG. 8 shows the plot of allowable range of modulator gain FM vs. LED-string voltage to achieve linear region operation of MOSFET according to one embodiment of the present invention.

FIG. 9 shows an exemplary LED driver circuit with a level shifter before the control circuit according to one embodiment of the present invention.

FIG. 10 shows the plot of allowable range of modulator gain FM as function of LED string voltage VLED with a 2.4-V level shifter according to one embodiment of the present invention.

FIG. 11 shows the plot of drain-to-source voltage VDS as a function of modulator gain FM for different voltage-shifting levels VLS according to one embodiment of the present invention.

FIG. 12 shows an exemplary LED driver circuit with a Zener diode before the control circuit according to one embodiment of the present invention.

FIG. 13 shows an exemplary LED driver circuit with a differential amplifier before the control circuit according to one embodiment of the present invention.

FIG. 14 shows an LED driver according to one embodiment of the present invention that employs a SEPIC pre-regulator.

FIG. 15 shows an LED driver with a feedback circuit consisting of error amplifiers, diodes, and a voltage divider.

FIG. 16 shows an LED driver with a feedback circuit consisting of error amplifiers, a Zener diode, and a voltage averaging resistor network.

FIG. 17 shows an LED driver with a feedback circuit consisting of error amplifiers, a voltage averaging resistor network, and a voltage divider.

FIG. 18 shows an LED driver with adaptively-controlled supply voltage for linear current regulators via a feedback circuit consisting of error amplifiers, and a voltage averaging resistor network.

FIG. 19 shows an adaptively-controlled LED driver with linear current regulators at the high side.

FIG. 20 shows an adaptively-controlled LED driver with individual linear dimming of LED strings.

FIG. 21 shows an adaptively-controlled LED driver with individual PWM dimming of LED strings.

FIG. 22 shows an adaptively-controlled LED driver with a dedicated PWM dimming controller.

FIG. 23 shows waveforms of output current and voltage with phased PWM dimming for two LED strings. Dimming duty cycle <0.5.

FIG. 24 shows waveforms of output current and voltage with phased PWM dimming for two LED strings. Dimming duty cycle >0.5.

FIG. 25 shows waveforms of output current and voltage with phased PWM dimming for three LED strings. Dimming duty cycle <⅓.

FIG. 26 shows waveforms of output current and voltage with phased PWM dimming for three LED strings. Dimming duty cycle >⅓.

### DETAILED DESCRIPTION OF THE INVENTION

An LED driver circuit according to the present invention uses a power supply having an adjustable output voltage, such as a switching pre-regulator, coupled to a plurality of parallel LED strings, or other kind of loads, comprising one or more LEDs to generate corresponding plurality of current flows in each LED string. Each LED string has a cumulative forward voltage that is the sum of the forward voltage of the one or more LEDs. Thus, each load is associated with a corresponding voltage drop. In one embodiment, each LED string comprises a sequence of a plurality of serially coupled LEDs of the same or different colors such that the anode of one LED in the sequence is coupled to the cathode of another LED in the sequence. A plurality of Linear Current Regulators (LCRs), each serially coupled to an LED string, regulate the current flow through each LED string.

In one embodiment and as further described below, each LCR of an LED string includes a current regulating transistor and a control circuit that generates a control signal that corresponds to the cumulative forward voltage of the LED string, with the control signal being used for controlling the current regulating transistor in order to maintain constant current flow through the LED string. The current regulating transistor can be made any type of suitable transistor. Exemplary current regulating transistors comprise MOSFETs, etc. In one exemplary embodiment, the control circuit of each LCR comprises a current sensor that senses the current flow through the corresponding LED string and a current error amplifier that generates a current error signal used for controlling the corresponding current regulating transistor of each LED string by comparing the sensed current flow with a reference signal. Accordingly, under this arrangement the error signal for each LED string corresponds to the cumulative forward voltage of the LED string. A comparator circuit selects the maximum current error signal associated with the sensed current flows through the plurality of LED string.

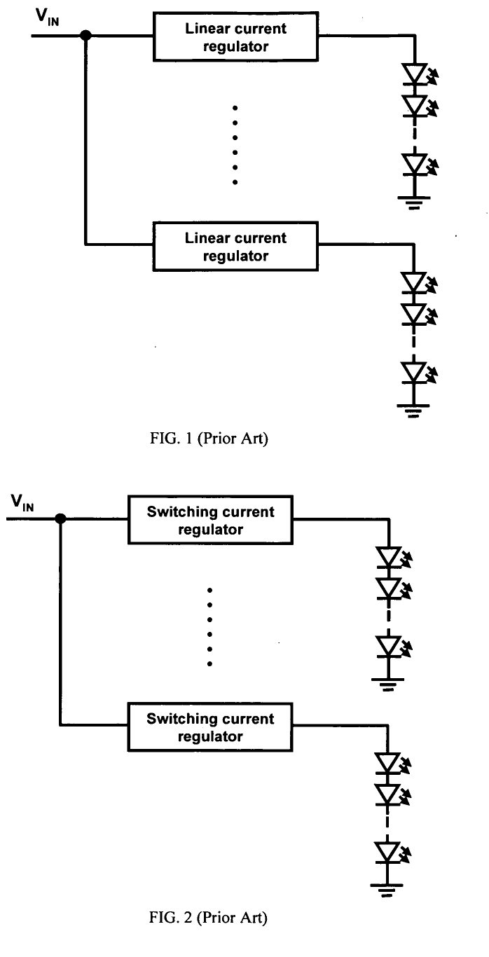

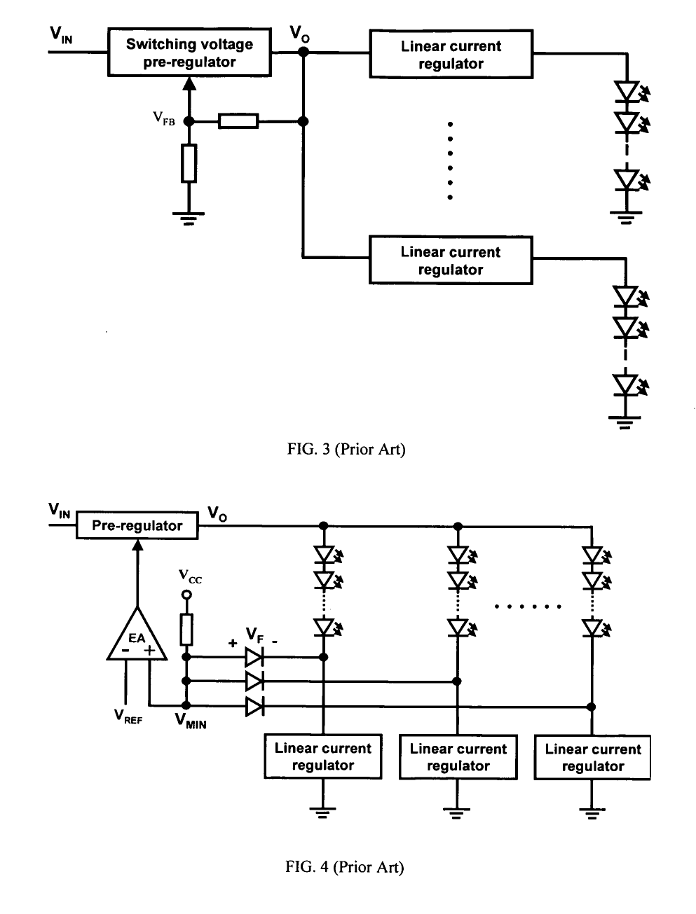

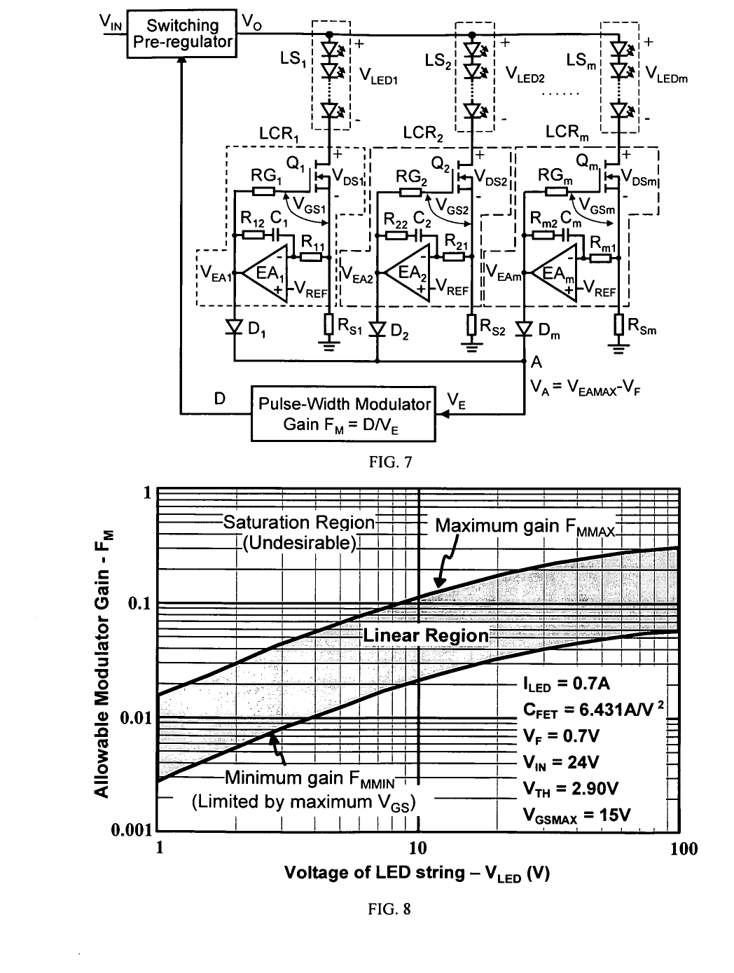

FIG. 5 shows an exemplary embodiment of the present invention, which overcomes the drawbacks of previously developed LED driver techniques, such as those described in connection with FIGS. 1-4, by operating at least one MOSFET in the linear region through a feedback loop, which adaptively supplies drive voltage to a plurality of LED strings (LS1-LSm) with optimal and consistent efficiency. The LED driver of FIG. 5 has a pre-regulator that receives an input voltage VIN to provide the drive voltage for the plurality of LED strings (LS1-LSm), which respectively present corresponding output loads, namely, Rload1-Rloadm. The exemplary pre-regulator can be a switching pre-regulator, as shown in FIG. 7. In this case, the control circuit is a pulse-width modulator (PWM).

The exemplary switching pre-regulators used in the LED driver of the invention can be a Boost, Buck, or Buck/Boost converters, depending on the applicable input and output voltage ranges. The current through each LED string (LS1-LSm) is regulated by a corresponding linear current regulator (LCR1-LCRm). Each linear current regulator (LCR1-LCRm) includes a current sensing resistor (RS1-RSm), an error amplifier (EA1-EAm), and a regulating transistor (Q1-Qm). The current through each LED string (LS1-LSm) is sensed by a current sensing resistor (RS1-RSm) and compared with a reference voltage VREF via an error amplifier (EA1-EAm). The error signal at the output of each error amplifier (EA1-EAm) controls the corresponding regulating transistor (Q1-Qm) to ensure that the current through the corresponding LED string (LS1-LSm) is equal to VREF/RSm. In this way, the error amplifier (EA1-EAm) with the highest output error signal corresponds to the LED string (LS1-LSm) that has the highest forward voltage drop.

In one exemplary embodiment, the outputs of all error amplifiers (EA1-EAm) for each of the LED strings (LS1-LSm) are “OR-ed” via diodes D1-Dm, which form a comparator for selecting the maximum error signal, which corresponds to the LED string having the highest voltage drop. As shown in FIG. 5, voltage VE at the common cathode of all diodes equals the highest output VEAMAX of all error amplifiers (EA1-EAm) minus forward voltage drop VF of the corresponding diode. VE is then applied to the input of the control circuit, and its output VCTL serves as a control signal to adjust the output voltage of the pre-regulator. In this way, the error amplifier (EA1-EAm) with the highest output takes control of the LED driver's feedback loop to adjust the output voltage of the pre-regulator to a minimum value that maintains constant current through the LED strings (LS1-LSm). For a switching pre-regulator, the control circuit, which could be a modulator, such as a PWM, generates a gate-drive voltage with a switching duty cycle D (D=FM*VE) for the voltage pre-regulator.

According to the forgoing description, a comparator circuit consisting of “OR-ed” diodes detects the maximum control signal, VEAMAX, i.e., the maximum output of the error amplifiers. The resulting signal, VE, which is VEAMAX minus VF, is used as the input of a control circuit for the pre-regulator, where VF is the forward voltage drop of the detection diodes. The output of the control circuit, VCTL, which is equal to FM*VE (FM is the gain of the control circuit), serves as the control signal for output voltage VO of the pre-regulator. Gain FM determines the output voltage level, thus plays a critical role in the operation mode of the MOSFET, and efficiency of the linear current regulator.

In order to minimize the power loss of the linear regulator, drain-to-source voltage VDS needs to be kept as low as possible, i.e., the output voltage of the pre-regulator is close to the voltage of the LED string. If gain FM is so low that output voltage VO is just enough to drive the LEDs so that drain-to-source voltage VDS is less than the difference of gate-to-source voltage VGS and turn-on threshold VTH of the MOSFET, i.e., VDS<(VGS−VTH), the MOSFET is forced to operate in the linear region, and LED current ILED can be expressed as:

$${I}_{LED} = {I}_{DS} = {C}_{FET} ( {V}_{GS} - {V}_{TH} - \frac{{V}_{DS}}{2} ) {V}_{DS} . \qquad ( 1 )$$

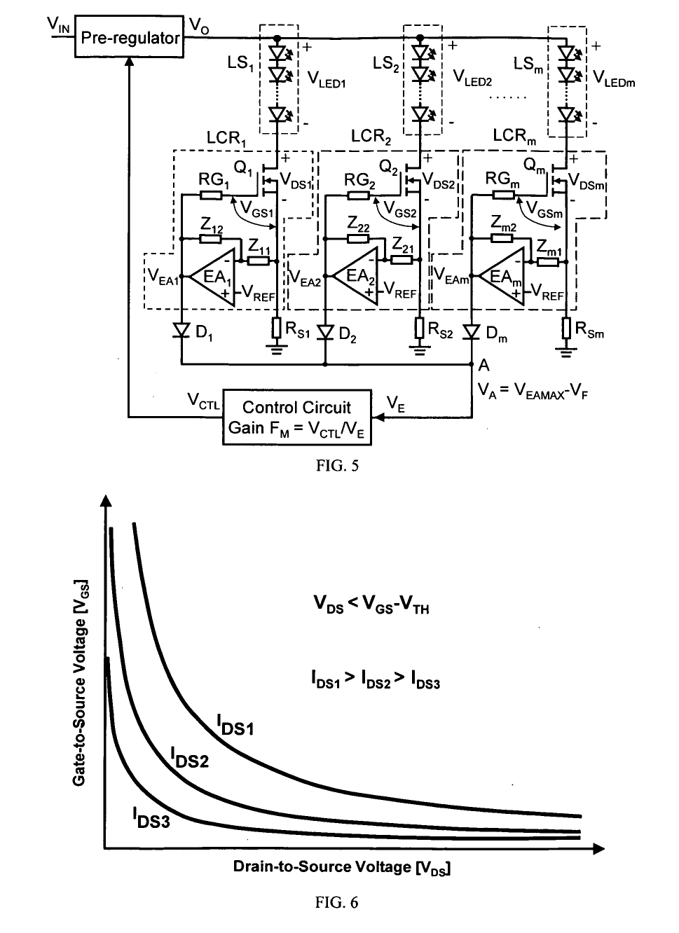

Rearranging the above equation gives the gate-to-source voltage:

$${V}_{GS} = \frac{{I}_{LED}}{{C}_{FET} {V}_{DS}} + {V}_{TH} + \frac{{V}_{DS}}{2} , \qquad ( 2 )$$

where C_{FET} is a constant of the MOSFET with a unit of A/V². According to equation (2), FIG. 6 shows a plot of gate-to-source voltage vs. drain-to-source voltage for different currents. It can be seen that a higher/lower V_{DS} corresponds to a lower/higher V_{GS} in the linear region for a given current. For an LED string with a maximum voltage, the drain-to-source voltage of the MOSFET is minimal, and the gate-to-source voltage, i.e., the output of the corresponding error-amplifier, is maximal. Therefore, the voltage that appears at the common cathode of all the diodes in the “OR” circuit, i.e, V_{E}, is the output voltage of the error-amplifier for the corresponding LED string with a maximum voltage minus the forward voltage drop of the detection diodes, and serves as the input of the control circuit.

The self-adjusting feature of the output voltage of the LED driver in the present invention can be further understood by considering its behavior in the presence of various disturbances. For example, if the voltage of the LED string with the highest voltage drop which controls the output voltage of the pre-regulator is increased, voltage VDS of the corresponding current-regulating MOSFET that already has the lowest VDS will decrease causing a decrease in its drain-to-source current IDS. As a result, the error between reference voltage VREF and current-sensing-resistor voltage will increase causing the output of the error amplifier, which is also gate-to-source voltage VGS, to increase to maintain the desired LED current. At the same time, the increased error-amplifier voltage that is also applied to the input of the modulator increases the duty cycle of the switching pre-regulator so that the pre-regulator output voltage is also increased to compensate for the LED voltage change.

The LED driver of the present invention also rejects changes of the pre-regulator input voltage. For example, if input voltage VIN is increased, output voltage VO will also increase causing the equal increase of the voltage VDS of the linear regulators. As a result, current IDS will also increase decreasing the error between reference voltage VREF and current-sensing-resistor voltage causing the output of the error amplifier, i.e., gate-to-source voltage VGS, to decrease to maintain the desired LED current. Since the decreased error-amplifier voltage is also applied to the input of the modulator, e.g., PWM of FIG. 7, the duty cycle of the switching pre-regulator will decrease, which will reduce the output voltage of the pre-regulator so that the input-voltage change are effectively rejected.

In should be noted that in this sensorless, adaptive drive-voltage method, the drive voltage is always self-adjusted to a minimum voltage required to maintain the desired current through the LED string with the maximum voltage drop. As a result, all linear current regulators in the LED driver of the present invention operate with minimized voltage drops, which makes the efficiency of the driver maximal.

As described above, by operating the MOSFET in the linear region, not only the power loss of the current-regulating MOSFET is kept minimum, but also the LED current and output voltage is regulated. Since the control circuit generates a control signal, i.e., VCTL, based on the detected maximum output voltage of the error-amplifiers, the output of the pre-regulator is adjusted to the lowest value required by the LED string that has the highest cumulative forward voltage. The adaptive control of the output voltage of the power supply according to the present invention, which is based on a feedback signal from the LED string with the highest cumulative forward voltage, eliminates the need for LED pre-selection (matching) and ensures operation at high efficiency by dynamically providing a minimum supply voltage to the linear current regulators.

In order to minimize the power loss of the current-regulating MOSFET, output voltage VO of the pre-regulator needs to be minimum to drive the LEDs, i.e.,

V_{O}=V_{LED}+V_{DS}+V_{RS}≈V_{LED} (4)

since for linear current regulators with the current-regulating MOSFET operating in the linear region, V_{DS}<<V_{LED}, whereas current-sensing resistor value R_{S} can always be selected so that V_{RS}=R_{S}I_{LED}<<V_{LED}.

Assuming a buck-boost type pre-regulator, i.e.,

$${V}_{O} = \frac{D}{1 - D} {V}_{IN} \qquad ( 5 )$$

and using modulator input-to-output relationship

D=F_{M}V_{E}=F_{M}(V_{GS}−V_{F}) (6)

to eliminate D from (5), the gate-to-source voltage that is required to provide desired output voltage can be obtained as:

$${V}_{GS} = \frac{{V}_{LED}}{{V}_{LED} + {V}_{IN}} \frac{1}{{F}_{M}} + {V}_{F} . \qquad ( 7 )$$

Preferably, the range of gate-to-source voltage VGS is constrained between minimum value VGSMIN, which is above threshold voltage VTH, and maximum value VGSMAX that is below the gate-to-source breakdown voltage. In this way, the range of modulator gain FM is also constrained. From (7), the allowable modulator gain range can be obtained as:

$$\frac{{V}_{LED}}{{V}_{LED} + {V}_{IN}} \frac{1}{{V}_{GS MAX} - {V}_{F}} < {F}_{M} < \frac{{V}_{LED}}{{V}_{LED} + {V}_{IN}} \frac{1}{{V}_{GS MIN} - {V}_{F}} . \qquad ( 8 )$$

Minimum gate-to-source voltage VGSMIN required to provide desired LED current ILED and at the same time maintain the MOSFET operation in the linear region can be calculated from (2) by recognizing that at the boundary of the linear and saturation regions, VDS=VGS−VTH so that relationship (2) can be written as:

$$\begin{matrix}{I}_{DS} = \frac{1}{2} {{C}_{FET} ( {V}_{GS} - {V}_{TH} )}^{2} & ( 9 ) \\ so that & \\ {V}_{GS MIN} = \sqrt{\frac{2 {I}_{LED}}{{C}_{FET}}} + {V}_{TH} & ( 10 ) \\ {F}_{M} \leq \frac{{V}_{LED}}{{V}_{LED} + {V}_{IN}} \cdot \frac{1}{\sqrt{2 \frac{{I}_{LED}}{{C}_{FET}} + {V}_{TH} - {V}_{F}}} . & ( 11 )\end{matrix}$$

Relationship (11) is shown in FIG. 8 as a plot of an allowable modulator gain range as a function of LED-string voltage VLED for a current-regulating MOSFET employing IRF540 device (VTH=2.90 V, CFET=6.41 A/V2) and operating in the linear region with IDS=ILED=0.7 A, assuming input voltage VIN=24 V, and OR-ing diode voltage drop VF=0.7 V. In FIG. 8, any modulator gain below FMMAX will lead to operation in the linear region of the MOSFET. For example, for a string voltage in the range from 56 V to 80 V, which corresponds to a string of 16 LEDs, a modulator gain of around 0.2 can be chosen. However, for a string voltage range of 3.5 V to 5 V that corresponds to one LED, the modulator gain may be kept below 0.05, i.e., around 0.04. In this case, according to equations (2), (3), and (7), VO=3.83 V, VGS=3.88 V, and VDS=0.12 V when FM=0.04, IDS=ILED=0.7 A, VLED=3.5 V, and VRS=0.21 V. The power loss of the MOSFET is 84 mW, and the efficiency of the current regulator is 91.38%. The selection of a lower modulator gain results in a lower power loss in the linear current regulators because a lower modulator gain requires a larger gate-to-source voltage VGS and, therefore, reduces drain-to-source voltage VDS.

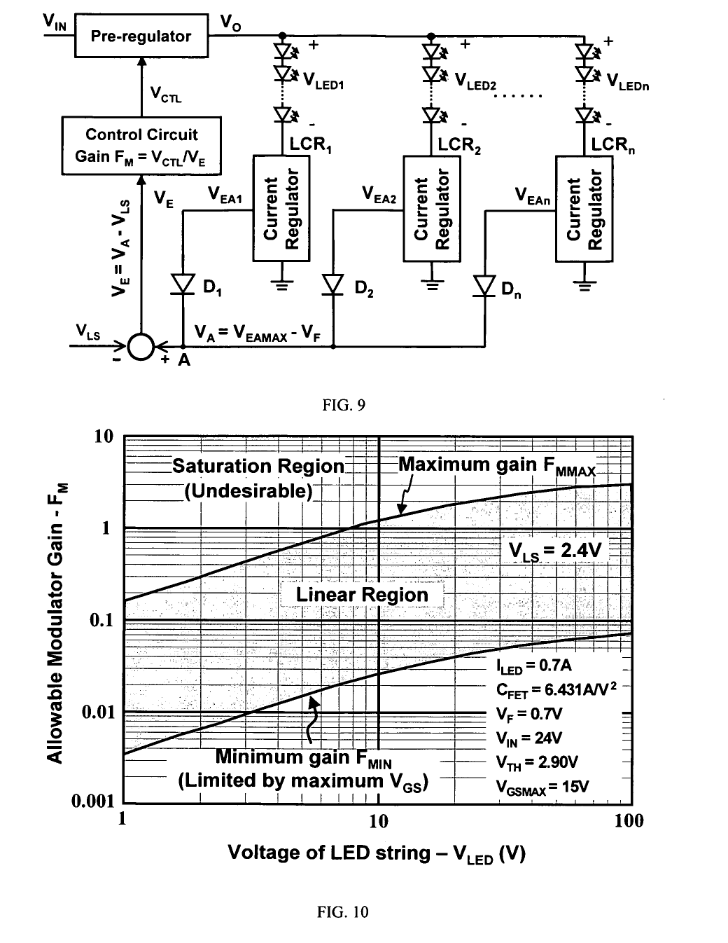

The performance of the LED driver of the present invention can be improved by employing a level shifter to reduce the voltage at the input of the modulator, as illustrated in FIG. 9. By subtracting a fixed voltage VLS from voltage VE, the gain of the modulator can be increased without adversely affecting the current regulation or efficiency performance of the LED driver.

Following the same derivation procedure as for the case without voltage level shifting, the maximum modulator gain for a Buck-Boost pre-regulator can be derived as:

$${F}_{M} \leq \frac{\frac{{V}_{LED}}{{V}_{LED} + {V}_{IN}}}{\sqrt{2 \frac{{I}_{LED}}{{C}_{FET}}} + {V}_{TH} - {V}_{F} - {V}_{LS}} ( {V}_{LS} < {V}_{LSCRIT} ) \qquad ( 12 )$$

where critical voltage shift level V_{LSCRIT} is defined as:

$${V}_{LSCRIT} = \sqrt{2 \frac{{I}_{LED}}{{C}_{FET}}} - {V}_{F} + {V}_{TH} \qquad ( 13 )$$

When VLS≧VLSCRIT, VGS is always greater than required VGSMIN to maintain desired ILED, regardless of modulator gain FM.

Minimum modulator gain FM that is constrained by the maximum gate-to-source breakdown voltage is given by:

$${F}_{M} > \frac{{V}_{LED}}{{V}_{LED} + {V}_{IN}} \frac{1}{{V}_{GS MAX} - {V}_{F} - {V}_{LS}} \qquad ( 14 )$$

Finally, the maximum voltage shift level for a given gain FM is limited to:

$${V}_{LS} \leq {V}_{GS MAX} - \frac{{V}_{LED MIN}}{{V}_{LED MIN} + {V}_{IN}} \frac{1}{{F}_{M}} - {V}_{F} \qquad ( 15 )$$

where V_{LEDMIN} is the minimum LED-string voltage.

FIG. 10 shows the plot of allowable range of modulator gain FM as a function of the LED-string voltage with a level shifter. Compared to the plot shown in FIG. 8 for the case without a level shifter, the maximum gain is increased significantly for the whole range of LED-string voltage under the same conditions. For example, with a 2.4-V level shift and for a string voltage in the range from 56 V to 80 V, a modulator gain of around 2 can be chosen, whereas for a string voltage range of 3.5 V to 5 V, the modulator gain can be as high as 0.4. These two gains are about ten times the gains for the case without a level shifter.

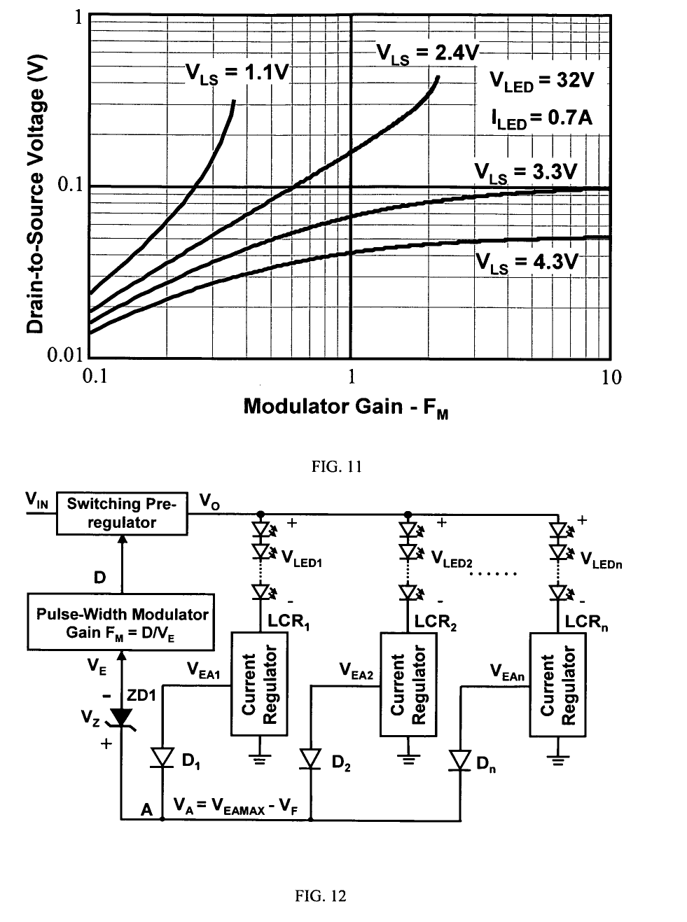

Since level shift affects the gate-to-source voltage VGS, it also affects the power loss of the MOSFET, as illustrated in FIG. 11. For the same modulator gain FM and LED current ILED, a higher voltage shift level gives a lower drain-to-source voltage, i.e., a lower power loss. For a target power loss, a higher shifting level allows a higher modulator gain. For an LED string with a voltage range from 32 V to 46 V, and with FM=0.4, VGSMAX=15 V, VF=0.7 V, and VIN=24 V, the maximum shifting level is 12.87 V, so a shifting level of 4.3 V can be chosen, VGS will range from 6.43 V to 6.63 V. The power loss of the MOSFET is about 20 mW for ILED=0.7 A.

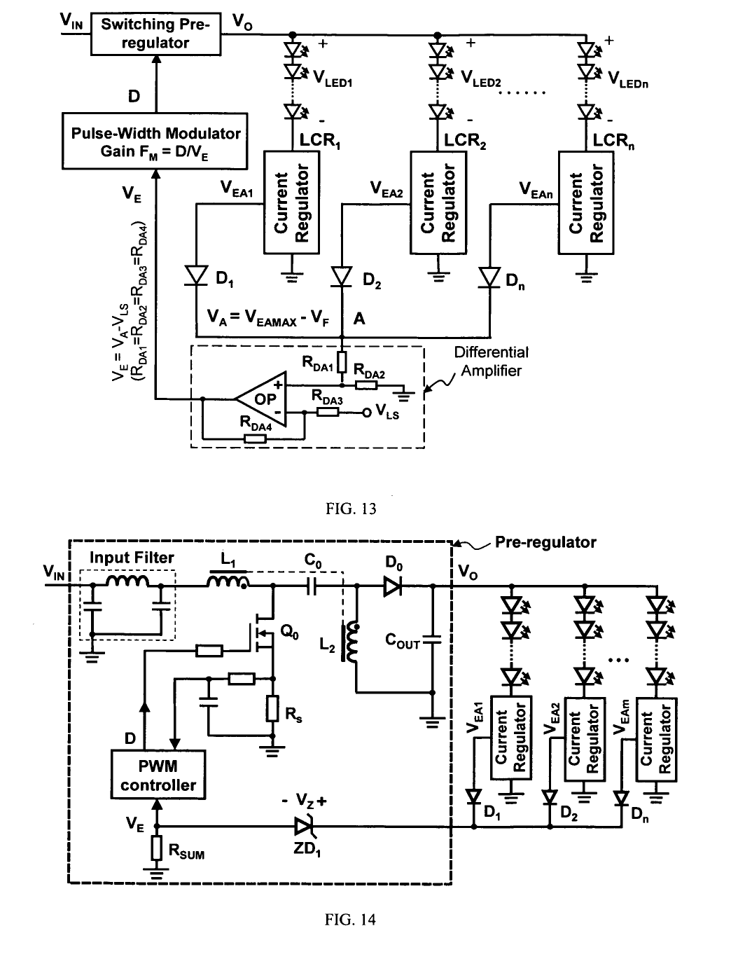

Exemplary level-shifters can be a Zener diode with a clamping voltage of VZ as shown in FIG. 12, or a differential-amplifier as shown in FIG. 13. The Zener diode reduces the output of the error-amplifier by a level VZ while the differential-amplifier reduces the output of the error-amplifier by a level VLS. FIG. 14 shows an LED driver according to one embodiment of the present invention that employs a SEPIC switching pre-regulator with a Zener diode for shifting the level of the maximum output of the error amplifiers.

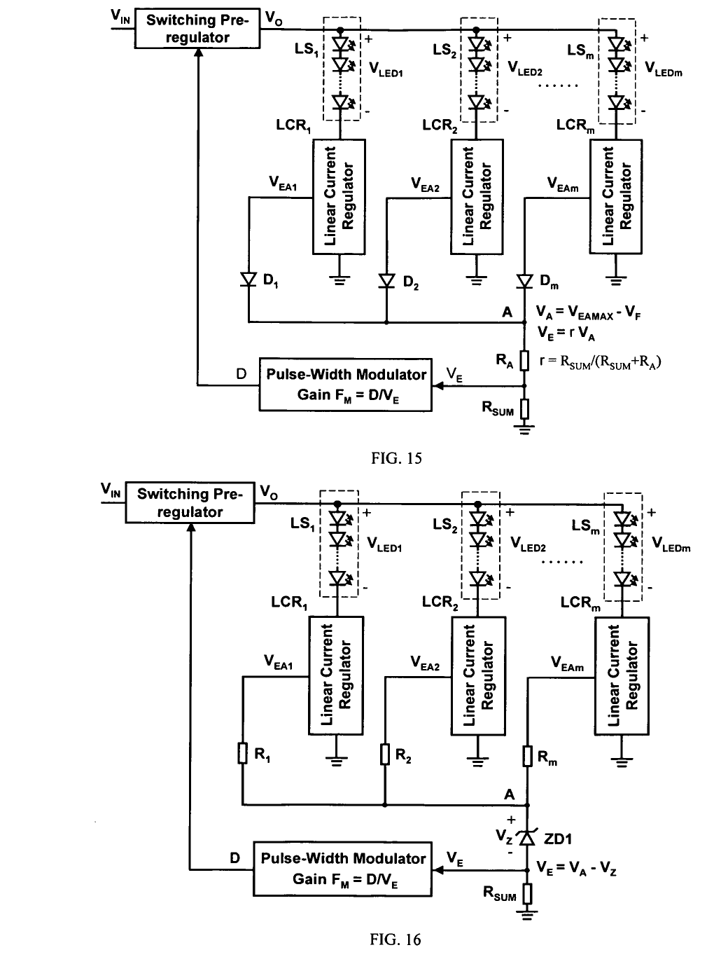

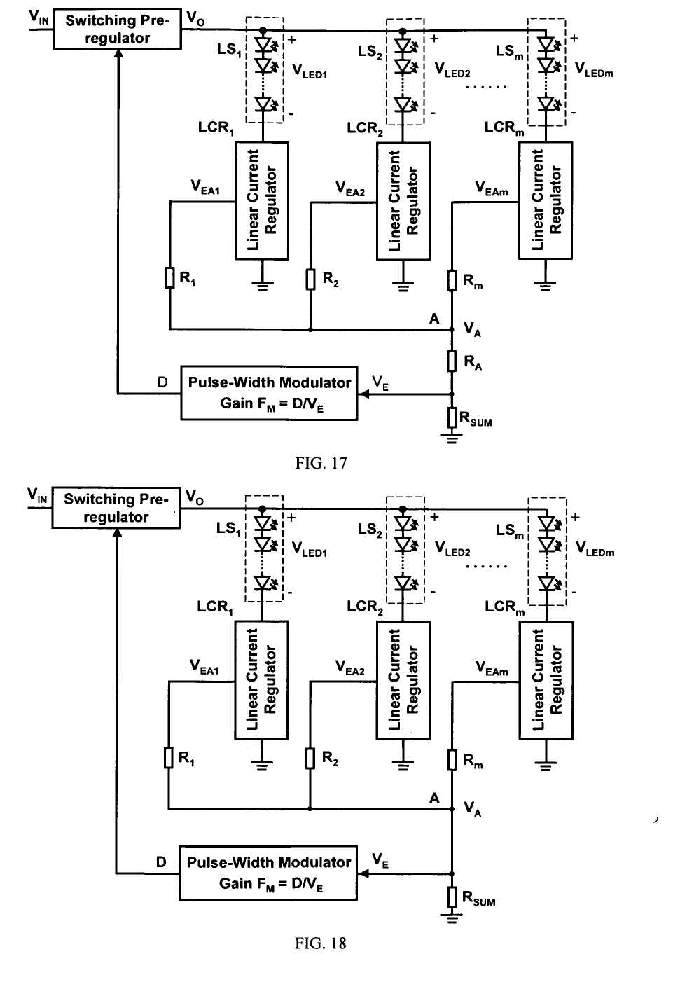

In addition to the aforementioned exemplary embodiments, other embodiments are possible to achieve minimum supply voltage for the LED strings and optimal efficiency of the LED driver. FIG. 15 shows another exemplary embodiment that uses a voltage divider for reducing the input to the control circuit, e.g., a modulator such as a PWM, and increasing the gain of the control circuit. FIG. 16 shows an LED driver with a feedback circuit consisting of error amplifiers, a Zener diode, and a voltage averaging resistor network, where diodes D1-Dm of FIG. 12 are replaced with resistors R1-Rm. FIG. 17 shows an LED driver with a feedback circuit consisting of error amplifiers, a voltage averaging resistor network, and a voltage divider, where the Zener diode ZD1 of FIG. 16 is replaced with resistor RA. FIG. 18 shows an LED driver with adaptive-controlled supply voltage for linear current regulators via a feedback circuit consisting of error amplifiers, and a voltage averaging resistor network, where resistor RA of FIG. 17 is removed.

Resistors RA, RSUM, and R1-Rm shown in LED drivers of FIGS. 15, 17, and 18 are so selected to ensure that the input to the PWM/modulator control circuit is low and the net gain of the voltage loop is low enough to achieve minimum output voltage VO to drive the LED strings. However, a low net gain of the voltage loop is not desirable in terms of loop regulation performance.

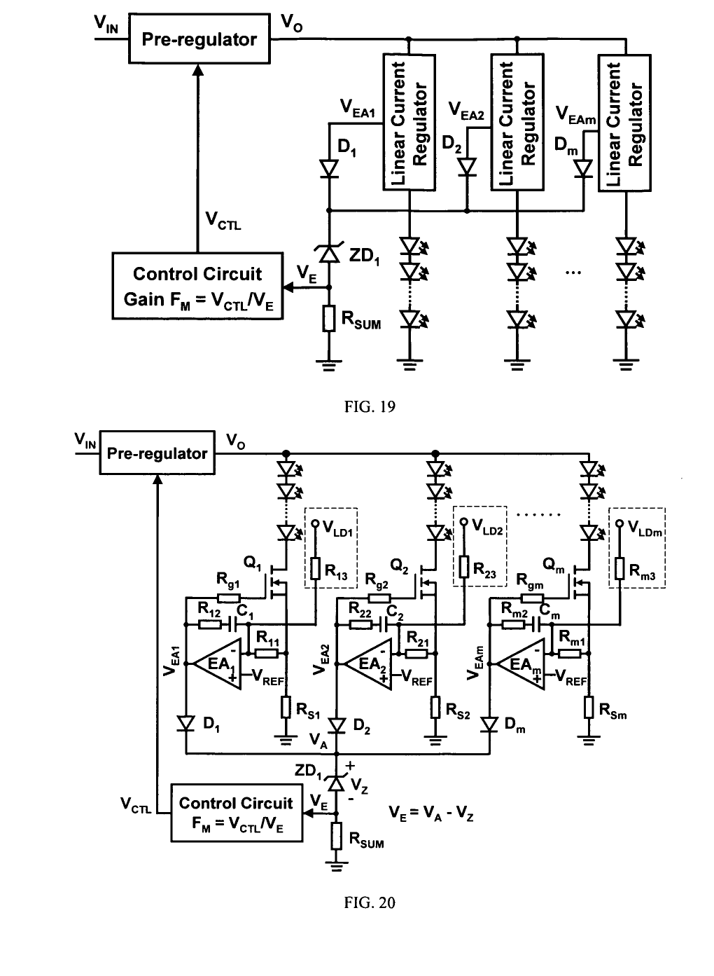

FIG. 19 shows another exemplary embodiment of the present invention where a plurality of parallel coupled linear current regulators placed at high side. i.e., coupled directly at their respective inputs to the switching pre-regulator for supplying regulated current and at their outputs to a corresponding plurality of LED strings (LS1-LSm). This circuit configuration allows that all the LED strings (LS1-LSm) to have the same return to the ground at cathodes, reducing wire connections between the power module and LED module. Accordingly, the level shifter shifts the maximum output of the error-amplifiers by a fixed level so that the input to the voltage loop control circuit is reduced and the gain of the control circuit can be increased to improve the voltage loop regulation performance.

The brightness of each LED string powered by the driver circuit of present invention can be individually adjusted via analog dimming or pulse-width-modulation (PWM) dimming. Analog dimming is achieved by applying a variable dc signal to either the inverting terminal or non-inverting terminal of the current error amplifier to adjust the current level of LEDs. FIG. 20 shows an adaptive-controlled LED driver with individual analog dimming of LED strings by applying a dc signal to the inverting terminal of the error amplifier.

PWM dimming employs a square wave signal with variable pulse width to allow or interrupt the LED string current flow. In essence, the driver adjusts the average current in a load by coupling a variable control signal for varying the averaged current of the load to a corresponding current regulating transistor. As further described below, the varying control signal for varying the averaged current of the load comprises at least one of a variable DC control signal or a pulse-width-modulated (PWM) control signal.

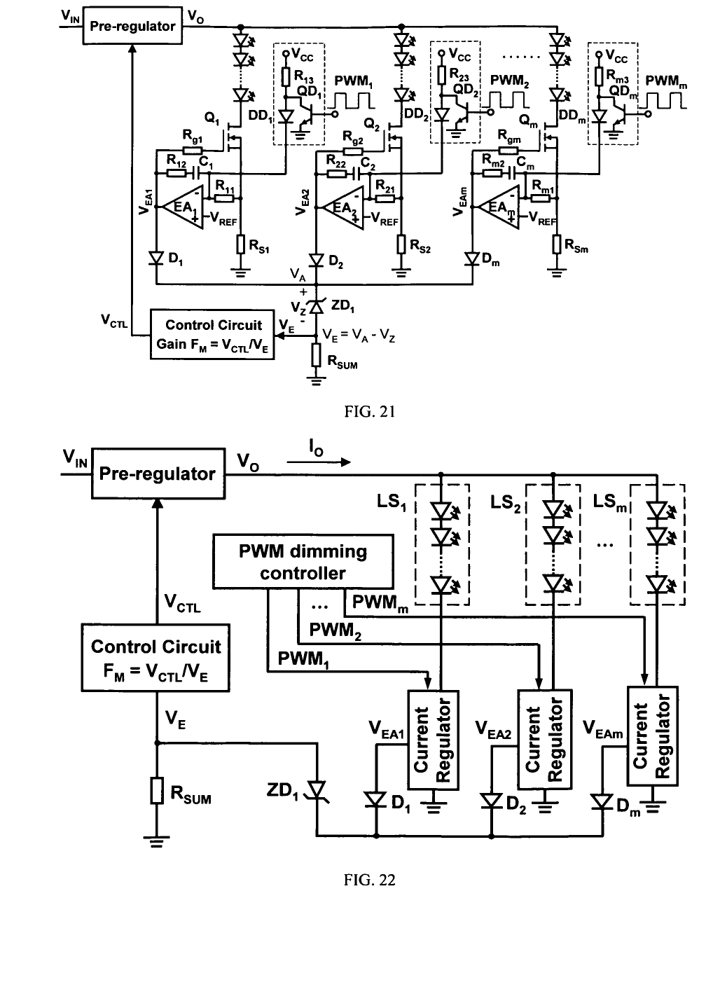

The frequency of the PWM dimming control signal is typically in the 100 Hz to 400 Hz range. Varying the pulse width of dimming control signals changes the average load current, hence the brightness of LEDs. An exemplary PWM dimming control circuit is shown in FIG. 21. When the PWM control signal is high, switch QD1, QD2, . . . , or QDm is turned on, the anode of DD1, DD2, . . . , or DDm is pulled low and reverse biased, the corresponding current feedback loop is not affected, and the LEDs are lit with the required current. However, when the PWM control signal is low, switch QD1, QD2, . . . , or QDm is turned off, diode DD1, DD2, . . . , or DDm conducts. By properly designing the voltage divider consisting of resistors Ri1 and Ri3 (i=1, . . . , m) so that the voltage across resistor Ri1, i.e. Ri1(VCC−VF)/(Ri1+Ri3), is greater than reference voltage VREFi (VF is the forward voltage drop of diodes DDi), the output of error amplifier EAi becomes low when PWMi is low, turning off current regulating transistor Qi, and corresponding LED string. The LED string with the next highest voltage drop then sets control voltage VE. In the case all PWM dimming signals are simultaneously low, diodes D1 to Dm are all reverse biased, and control voltage VE decreases to zero, preventing the pre-regulator from continuing to charge the output capacitor when all the LED strings are turned off.

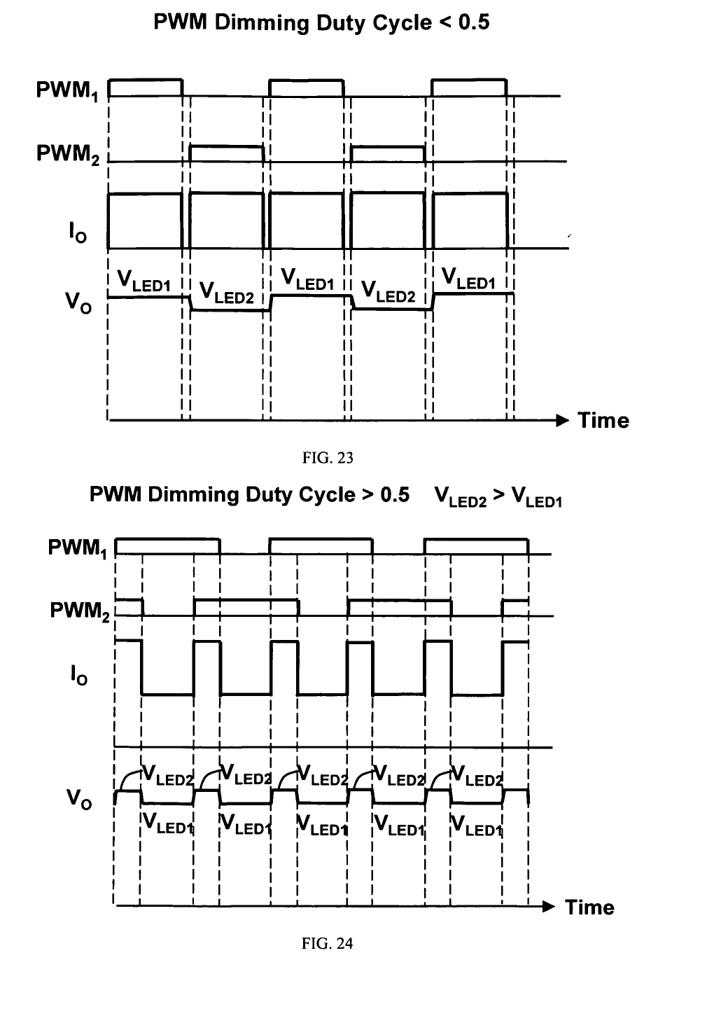

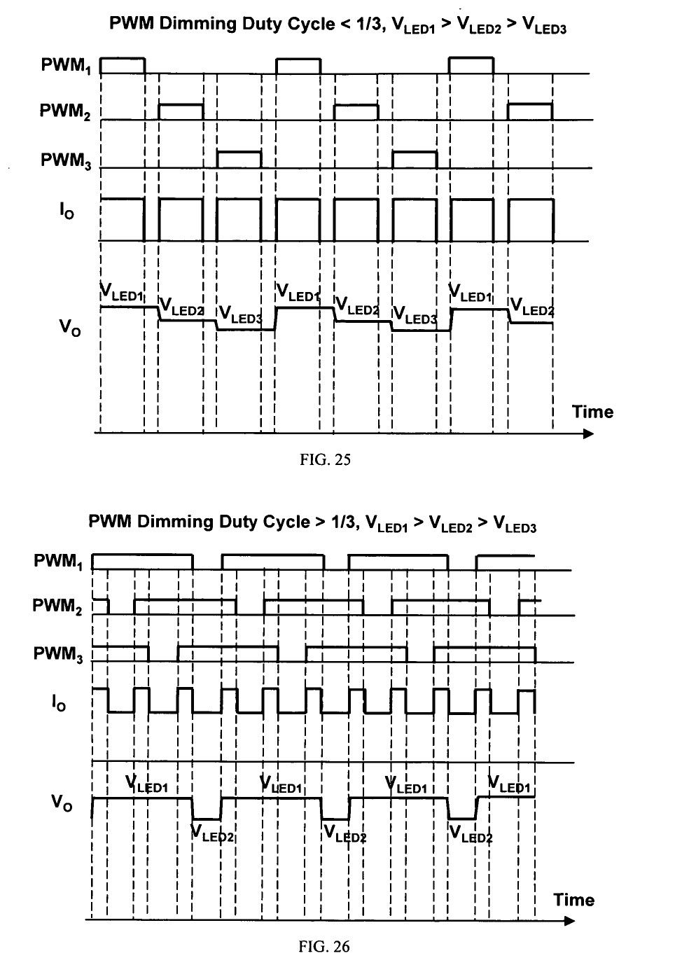

The major drawback of PWM dimming is that, if all the LED strings are turned on or off simultaneously, the input power undergoes abrupt changes periodically, causing large pulsating input/output current, degraded EMI performance, decreased operating efficiency, and increased power bus ripple. In order to alleviate this problem, sequential PWM dimming, can be applied, as described by M. Doshi and R. Zane (“Digital architecture for driving large LED arrays with dynamic bus voltage regulation and phase shifted PWM,” IEEE Applied Power Electronics Conference (APEC) Proc., pp. 287-293, 2007). With sequential PWM dimming, the present invention offers adaptive drive voltage without extra circuit such as voltage comparators to maximize the operating efficiency. This type of dimming employs phased PWM dimming control signals to adjust LED brightness, which means different LED strings draw the power consecutively by a certain phase delay rather than simultaneously. A dedicated PWM dimming controller, e.g., a micro-controller, or a dimmer IC, as shown in FIG. 22, fulfills the function of generating phase-shifted PWM dimming control signals. With the LED driver of the present invention, not only the instantaneous output current drawn from the pre-regulator can be reduced, but also output voltage VO of the pre-regulator is self-adjusted to a voltage that results in a maximum operating efficiency. For example, if there are two LED strings driven by the LED driver and dimmed sequentially, output voltage VO of the pre-regulator will vary between VLED1 and VLED2 as shown in FIG. 23 for a PWM dimming duty cycle is less than 0.5. As seen from this figure, only one LED string is turned on at any time and the output current of the pre-regulator has an amplitude equal to the current flowing through one LED string, which is half the amplitude of the output current for non-sequential PWM dimming. Output voltage Vo is VLED1 when only LED string LS1 is turned on, and VLED2 when only LED string LS2 is turned on. FIG. 24 shows waveforms when the PWM dimming duty cycle is greater than 0.5. For VLED2>VLED1, output voltage Vo is VLED2 whenever string LS2 is turned on, and adjusted to VLED1 when only string LS1 is turned on. FIGS. 25-26 further show waveforms for an LED driver with three LED strings according to the present invention. When the PWM dimming duty cycle is less than ⅓, as shown in FIG. 25, only one LED string is turned on at any time, the output voltage of the pre-regulator tracks the string voltage in a step fashion, resulting in minimum voltage drop across the linear current regulators. When the PWM dimming duty cycle is greater than ⅓, as shown in FIG. 26, there exists overlapped turn-on time between LED strings, the output voltage of the pre-regulator always tracks the maximum of LED string voltages. It is noted that as the PWM dimming duty cycle goes lower, the benefit of phased PWM dimming is more prominent since the overlapped time is shorter and each LED string is driven with a more optimized drive voltage.

Accordingly, the power supply provides constant current to multiple loads, such as LEDs. In one embodiment, the power supply is a switching pre-regulator that supplies currents to multiple LED strings each coupled in series to a linear current regulator. By properly designing the voltage loop gain, a minimum output voltage of the pre-regulator is achieved for maximum overall operating efficiency, and at least one of the current-regulating transistors operates in the linear region. The output voltage of the pre-regulator is the sum of the load voltage, voltage drop of the corresponding current regulating transistor operating in the linear region, and the voltage drop of the current sensing resistor for the load. Regardless of the tolerance of the voltage drop of the loads, the output voltage of the pre-regulator is adaptively adjusted and the load current is regulated based on the relatively strong dependence of the gate-to-source voltage on the drain-to-source voltage of the current-regulating transistor operating in the linear region. In one embodiment, a voltage-scaler circuit including a voltage divider ensures the net gain of the voltage loop is low enough to provide a minimum supply voltage, and allow at least one of the current-regulating transistors, e.g., a MOSFET to operate in the linear region. In another embodiment, a level-shifter circuit including a Zener diode or a differential amplifier shifts the maximum output of the error-amplifiers by a fixed level so that the input to the voltage loop control circuit is reduced and the gain of the control circuit can be increased to improve the voltage loop regulation performance.

The average current of each load can be adjusted by an analog or PWM control signal, e.g., the brightness of LEDs can be controlled by analog dimming or PWM dimming. With sequential PWM dimming, the LED driver of the present invention reduces the instantaneous input/output power, and also achieves variable drive voltage based on the maximum voltage of all the LED strings that are turned on, maximizing the overall operating efficiency of the LED driver.

From the forgoing it would be appreciated that, the LED driver of the present invention comprises a voltage pre-regulator and multiple linear current regulators with an adaptive-controlled supply voltage that supplies current to corresponding LED strings. The present invention senses the current through each LED string and uses a feedback signal to adjust the output voltage of the pre-regulator to the lowest level required by the LED string that has the highest forward voltage. Regardless of the tolerance of the LED forward voltage drop, which highly depends upon the manufacture process and operating temperature, the driver circuit of present invention powers LEDs with a constant current, providing consistent illumination and high efficiency at low cost by eliminating the need for LED pre-selection (matching) or manufacture to a close tolerance. It is suitable for use with lower cost LEDs or LEDs having a broad parameter tolerance over wide source voltage range and temperature variation.

Although the present invention has been described with reference to a certain preferred embodiment, numerous modifications and variations can be made by those skilled in the art without departing from the novel spirit and scope of the invention. Therefore, it is intended that the invention is not limited to the particular embodiment disclosed as the best mode contemplated for carrying out the invention, but that the invention will include all embodiments falling within the scope of the appended claims.

1. A driver comprising:
a power supply having an adjustable output voltage;
a plurality of loads coupled to the adjustable output voltage in parallel to generate a plurality of current flows through each load, wherein each load has a corresponding voltage drop;
a plurality of control circuits coupled to a corresponding one of the plurality of the loads for generating a plurality of control signals, each control signal having a level that corresponds to the voltage of a correspondingly coupled load;
a plurality of current regulating transistors, each current regulating transistor regulating the current flow through a corresponding one of the plurality of loads in response to a correspondingly coupled control signal of the plurality of control signals;
a detector that detects a control signal corresponding to the highest voltage drop of one of the plurality of loads;
a feedback control circuit that provides a control signal corresponding to the detected control signal for adjusting the output voltage of the power supply.

2. The driver of claim 1, wherein at least one of the plurality of control signals comprises an error signal derived from a sensed current flow through a load and a reference signal.

3. The driver of claim 1, wherein the detector circuit comprises a plurality of diodes.

4. The driver of claim 1, wherein the power supply comprises a pre-regulator power supply.

5. The driver of claim 4, wherein the pre-regulator power supply comprises at least one of a switching or a linear power supply.

6. The driver of claim 1, wherein at least one of the current regulating transistors comprises a MOSFET.

7. The driver of claim 1, wherein the average current in a load is adjusted by coupling a variable control signal for varying the average current of the load to a corresponding current regulating transistor.

8. The driver of claim 1, wherein the varying control signal for varying the average current of the load comprises at least one of a variable DC control signal or a pulse-width-modulated (PWM) control signal.

9. The driver of claim 8, wherein the PWM control signal comprises a phase-shifted control signal.

10. The driver of claim 1, wherein the feedback control signal adjusts the output voltage so that the current regulating transistors maintain current regulation with a minimum power supply voltage.

11. The driver of claim 1, wherein at least one of the plurality of loads comprises an LED string.

12. The driver of claim 1, wherein at least one current regulating transistor is operated in the linear region.

13. The driver of claim 1, further comprising a level shifter that shifts the level of the detected control signal.

14. The driver of claim 13, wherein the level shifter comprises at least one of a Zener diode, a voltage divide network or a differential amplifier.
